(19) United States
(12) Patent Application Publication
(10) Pub. No.: US 2014/0074532 A1
(43) Pub. Date: Mar. 13, 2014

(54) INFORMATION NOTIFICATION APPARATUS AND NON-TRANSITORY COMPUTER-READABLE RECORDING MEDIUM

(71) Applicant: CASIO COMPUTER CO., LTD., Tokyo (JP)

(72) Inventors: Kimiyasu MIZUNO, Akishima-shi (JP); Yoshiaki NAKAMURA, Ome-shi (JP); Yuki YOSHIHAMA, Inagi-shi (JP); Taisuke KOROKU, Sagamihara-shi (JP)

(73) Assignee: CASIO COMPUTER CO., LTD., Tokyo (JP)

(21) Appl. No.: 14/015,992

(22) Filed: Aug. 30, 2013

(30) Foreign Application Priority Data
Sep. 10, 2012 (JP) 2012-198249

(51) Int. Cl. G06Q 10/10

(52) U.S. Cl. CPC G06Q 10/1093
USPC 705/7.18

(57) ABSTRACT

An information notification apparatus includes a schedule storage unit which stores schedule data, a special schedule determining unit which determines special schedule data in the schedule data stored in the schedule storage unit, and a special schedule notification unit which notifies a communication terminal of the special schedule data determined by the special schedule determining unit.

### CROSS-REFERENCE TO RELATED APPLICATIONS

This application is based upon and claims the benefit of priority from prior Japanese Patent Application No. 2012-198249, filed Sep. 10, 2012, the entire contents of which are incorporated herein by reference.

### BACKGROUND OF THE INVENTION

1. Field of the Invention

The present invention relates to an information notification apparatus for promoting person-to-person communications and a non-transitory computer readable recording medium for doing the same.

2. Description of the Related Art

A variety of communication apparatuses for performing person-to-person communications, such as a landline phone, a cellular phone and a videophone becomes widespread. These communication apparatuses allow remote persons to perform communications easily. For example, remote peoples in a family can report their current statuses to each other and talk about their worries to each other.

As a prior art communication apparatus, there is a communication destination selecting apparatus capable of displaying telephone directory information which is registered to make the numbers and names of a plurality of communication destinations correspond to each other and designating one of the names of the communication destinations to choose its corresponding communication destination easily (Jpn. Pat. Appln. KOKAI Publication No. 2001-111674).

As a variety of communication apparatuses become widespread, person-to-person communications are promoted using these communication apparatuses. In actuality, however, it is quite difficult to carry out communications even among parents, brothers and sisters, relatives or the like unless there are any topics or chances.

The present invention provides an information notification apparatus capable of causing a cue to perform person-to-person communications by making a notification about a special schedule and a non-transitory recording medium on which control programs for the information notification apparatus are recorded.

### BRIEF SUMMARY OF THE INVENTION

The information notification apparatus comprises a schedule storage unit which stores schedule data, a special schedule determining unit which determines special schedule data in the schedule data stored in the schedule storage unit, and a special schedule notification unit which notifies a communication terminal of the special schedule data determined by the special schedule determining unit.

The information notification apparatus therefore makes it possible to cause a cue to perform person-to-communications.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a general view showing a configuration of a communication promotion system using an information notification server 10 of an information notification apparatus according to an embodiment of the present invention;

FIG. 2A is a diagram showing a schedule registration input screen displayed on communication terminals 20A and 20B of users A and B by the information notification server 10;

FIG. 2B is a diagram showing another schedule registration input screen displayed on communication terminals 20A and 20B of users A and B by the information notification server 10;

FIG. 2C is a diagram showing still another schedule registration input screen displayed on communication terminals 20A and 20B of users A and B by the information notification server 10;

FIG. 3 is a block diagram showing a configuration of an electronic circuit of the information notification server 10;

FIG. 4 is a diagram showing management data stored in a schedule management memory 12c of the information notification server 10;

FIG. 5 is a diagram showing terms used for schedules stored in a usage term database 12d of the information notification server 10;

FIG. 6 is a diagram showing setting data stored in a user event notification destination setting table 12e of the information notification server 10;

FIG. 7 is a diagram showing special events stored in a special event database 12f of the information notification server 10;

FIG. 8 is a flowchart showing a special schedule analysis process to be performed by the information notification server 10;

FIG. 9 is a flowchart showing a special event notification process to be performed by the information notification server 10;

FIG. 10 is a table showing group terms stored in a group term database 12g of the information notification server 10; and

FIG. 11 is a flowchart showing a special event notification process (for each group) according to another embodiment which is performed by the information notification server 10.

### DETAILED DESCRIPTION OF THE INVENTION

Embodiments of the present invention will be described with reference to the accompanying drawings.

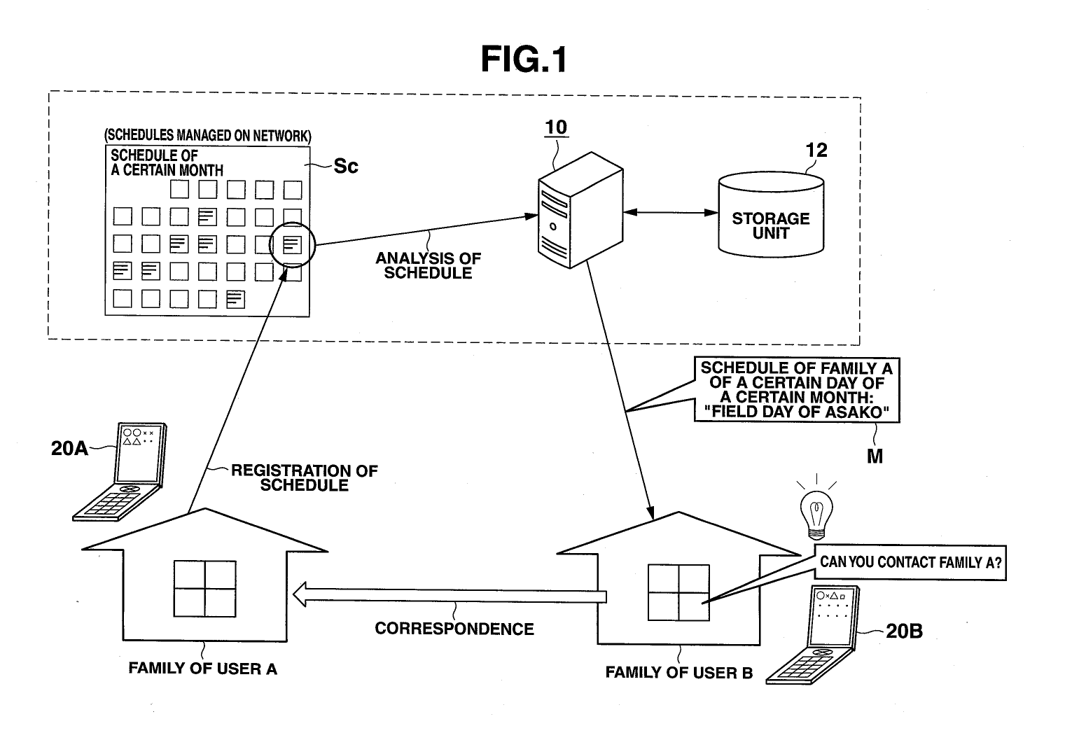

FIG. 1 is a general view showing a configuration of a communication promotion system using an information notification server 10 of an information notification apparatus according to an embodiment of the present invention.

The present embodiment is directed to a case where the communication promotion system is used for both users A and B who wish to promote their communications.

In order to use the communication promotion system, the schedules (date, time and items) Sc of users A and B are received from communication terminals 20A and 20B of these users and registered in the information notification server 10.

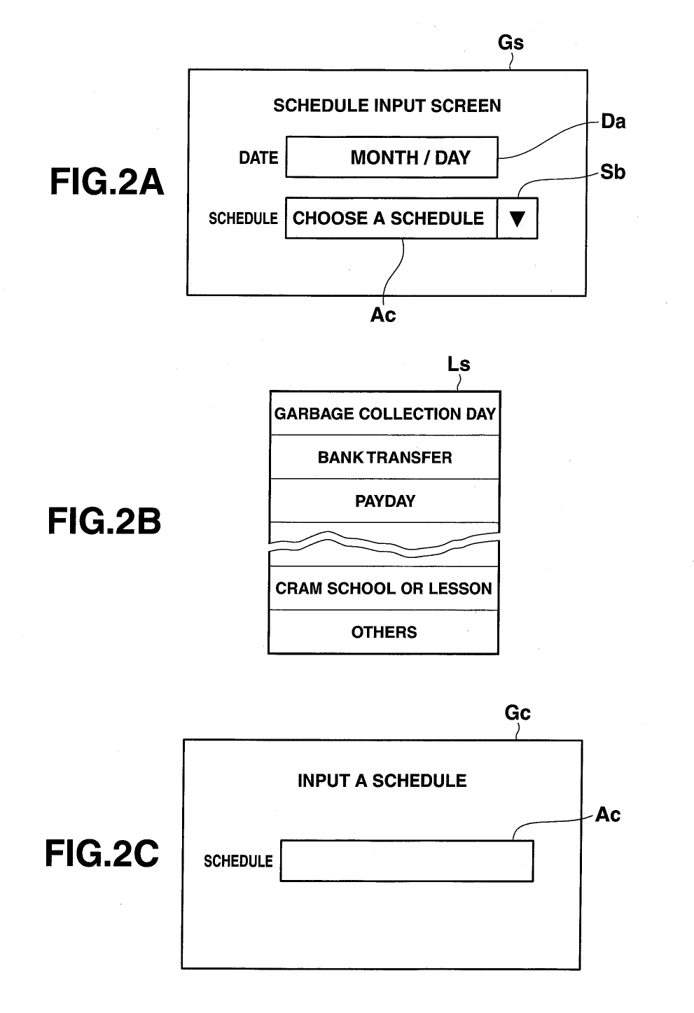

FIGS. 2A, 2B and 2C are diagrams each showing a schedule registration input screen displayed on communication terminals 20A and 20B of users A and B by the information notification server 10.

If one of users A and B gains access to the information notification server 10 from communication terminal 20A (20B) for user registration and then chooses an item to be registered as a schedule, a schedule input screen Gs is displayed as illustrated in FIG. 2A. The schedule input screen Gs includes a date (day/month/year) input area Da and an item input area Ac. The item input area Ac includes a menu choice button Sb.

If the menu choice button Sb is designated, a pull-down menu Ls indicating different regular schedules is displayed under the schedule input area Ac as illustrated in FIG. 2B. If the user chooses one of the schedule items other than “others” listed in the pull-down menu Ls, the chosen schedule item is input to the item input area Ac of the schedule input screen Gs and registered as a regular schedule.

If the “others” is chosen from the pull-down menu Ls, an item input screen Gc including the item input area Ac only is displayed. If a given schedule item is input to the item input screen Gc, the input item is displayed on the item input area Ac of the schedule input screen Gs and registered as a special schedule.

The information notification server 10 has a function of distinguishing and managing a schedule Sc which is registered by users A and B as a special event. The server 10 also has a function of monitoring the date and time of the registered schedule Sc and notifying communication terminal 20B of user B of a schedule before or after the registered schedule Sc if it is a schedule of user A and notifying communication terminal 20A of user A of a schedule before or after the registered schedule Sc if it is a schedule of user B.

The special events are identified as fewer ones that appear seasonally, yearly or irregularly, while the regular events are identified as more ones that appear daily, weekly, monthly or the like.

Assume that the family of user A includes a child and the family of user B includes the grandparents of the child. If the schedule Sc of the family of user A includes “a certain day of a certain month: Sports Day of Asako” identified as a special event, the information notification server 10 notifies communication terminal 20B of user B of the schedule of the special event via mail M beforehand.

Accordingly, the family of user B is able to have a positive motivation to try to contact the family of user A for the reason of the special event of user A that is notified to communication terminal 20B from the information notification server 10. Thus, users A and B are able to promote communications with each other.

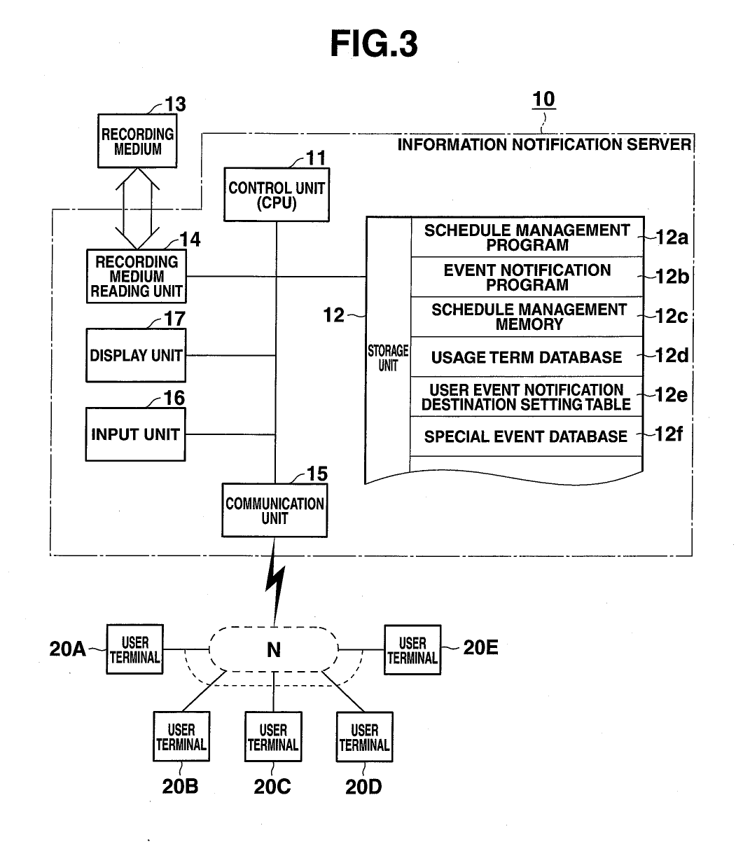

FIG. 3 is a block diagram showing a configuration of an electronic circuit of the information notification server 10.

The information notification server 10 includes a control unit (CPU) 11 as a computer.

The control unit (CPU) 11 controls the operations of the circuits and performs different functions thereof in accordance with a server control program stored in advance in a storage unit 12, a server control program read out of an external recording medium 13 through a recording medium reading unit 14 and then stored in the storage unit 12, or a server control program downloaded from a Web server on a communication network N (program server in this case) into the storage unit 12 through a communication unit 15.

As the server control programs stored in the storage unit 12, there is not only a system program for the entire control but also a schedule management program 12a for managing the schedules of users A and B who are registered, an event notification program 12b for distinguishing a special schedule from the schedules of users A and B, which are managed in accordance with the schedule management program 12a and notifying a user who is registered as a notification destination of the distinguished special schedule, and the like.

The storage unit 12 includes a working data area such as a schedule management memory 12c, a usage term database 12d, a user event notification destination setting table 12e and a special event database 12f.

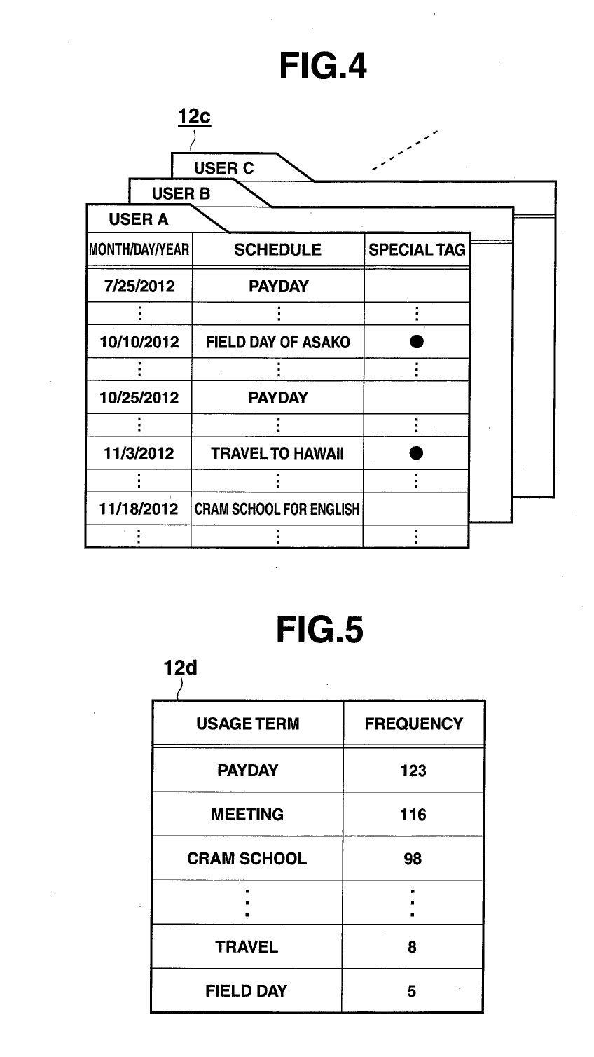

FIG. 4 is a diagram showing management data stored in the schedule management memory 12c of the information notification server 10.

The schedule management memory 12c stores the dates and items of schedules registered in response to access from communication terminals 10A and 10B of the registered users A and B of the information notification server 10. Of the registered schedules, special schedules are each stored with a tag added thereto. The schedules are erased at any time when their dates expire.

FIG. 5 is a diagram showing terms used for schedules stored in the usage term database 12d of the information notification server 10.

Whenever a schedule of each of users A and B is registered in the schedule management memory 12c, all of the nouns used for the schedule are extracted. The usage term database 12d thus stores the extracted nouns to correspond to their frequencies of use.

As the nouns used for schedules, there are “payday,” “meeting,” “cram school,” “travel,” “sports day” and the like. The usage frequency of “payday,” “meeting” and “cram school” is high, namely these are regular, whereas that of “travel” and “sports day” is low, namely these are special.

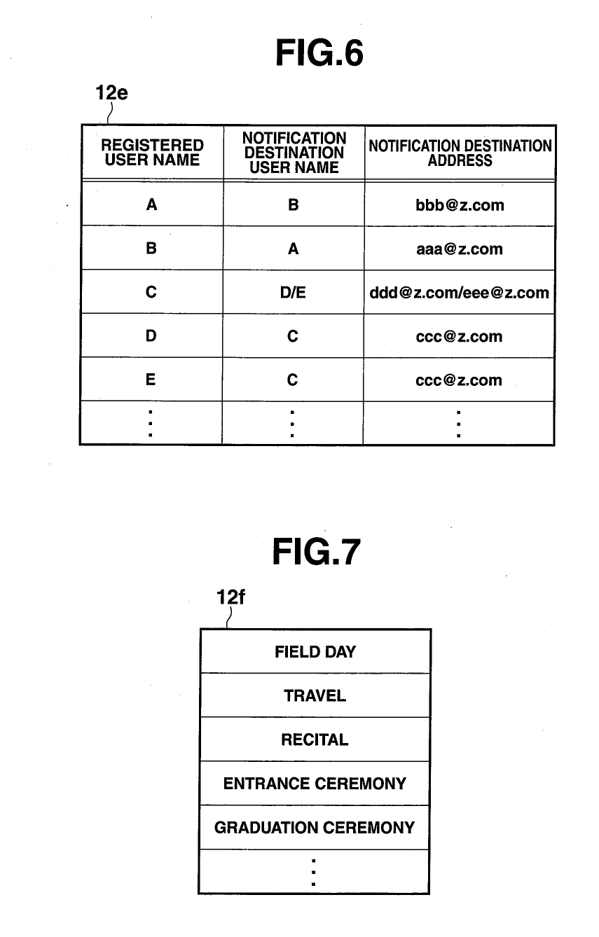

FIG. 6 is a diagram showing setting data stored in the user event notification destination setting table 12e of the information notification server 10.

The user event notification destination setting table 12e stores the name of one of users A and B and its mail address as a notification destination. The one of the users wishes to promote communications with the other user by notifying the other user of a special schedule after users A and B are registered in the information notification server 10 in response to access from communication terminals 10A and 10B of users A and B.

FIG. 7 is a diagram showing special events stored in the special event database 12f of the information notification server 10.

The special event database 12f previously stores terms of events for which not regular but special schedules are set. The events are, for example, “sports day,” “travel,” “recital,” “entrance ceremony” and “graduation ceremony.”

A tag indicating whether each of the schedules stored in the schedule management memory 12c is special is determined by one of the following three methods (1) to (3):

(1) A target schedule is determined according to whether it is a schedule that is input from the item input area Ac of the item input screen Gc by choosing “others” from the pull-down menu Ls of the schedule input screen Gs as shown in FIGS. 2A to 2C.

(2) A target schedule is determined according to whether it includes none of the terms stored in the usage term database 12d, the usage frequency of the terms being the fifth or more from the bottom.

(3) A target schedule is determined according to whether it includes one of the terms stored in the special event database 12f.

An input unit 16 and a display unit 17, which are operated and referred to by a server administrator, are connected to the control unit (CPU) 11. Moreover, the communication unit 15 is connected to the control unit (CPU) 11 to gain appropriate access to communication terminals 20A and 20B of users A and B on the communication network (Internet) N.

The information notification server 10 so configured fulfills a special schedule analysis function and a special schedule notification function as will be described below when the control unit (CPU) 11 controls the operations of the circuits in accordance with the instructions described in the server control programs 12a and 12b and operates with cooperation between software and hardware.

An operation of the information notification server 10 in the communication promotion system described above will be described below.

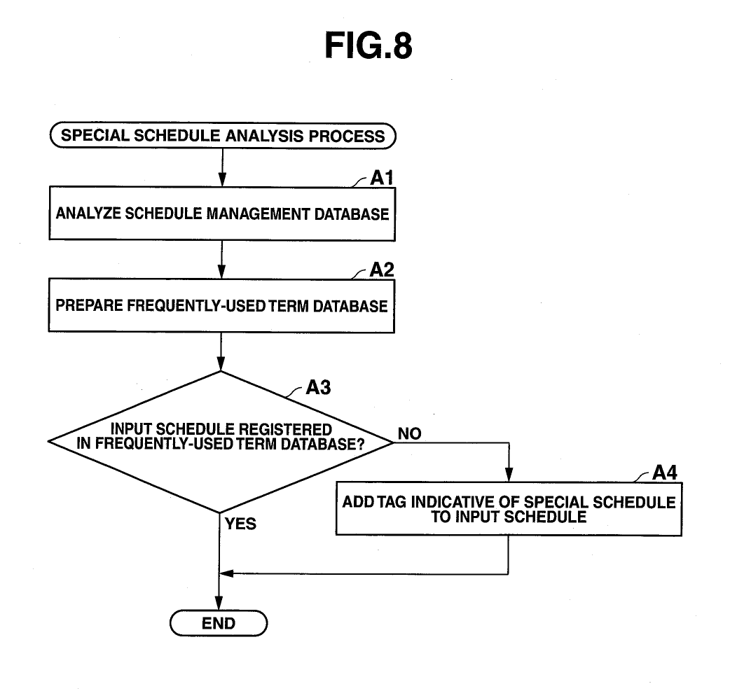

FIG. 8 is a flowchart showing a special schedule analysis process to be performed by the information notification server 10.

In the following descriptions, the above method (2) is employed to determine whether each of the schedules stored in the schedule management memory 12c is a special schedule.

The special schedule analysis process is performed for a schedule of each of users A and B using the information notification server 10 whenever the schedule is registered in the schedule management memory 12c or a schedule registered in the schedule management memory 12c regularly (at a fixed time every day, for example).

Assume that a user's schedule is input and registered in the schedule management memory 12c. When the special schedule analysis process is started, the usage term database 12d (see FIG. 5) is analyzed first (step A1). All of the nouns included in the registered schedule are extracted and stored in the usage term database 12d. A new term is stored with its usage frequency “1” added thereto, and the stored term is updated with its usage frequency “+1” added thereto (step A2).

Then, it is determined whether the registered schedule includes the terms stored in the usage term database 12d, the usage frequency of the terms being the fifth or more from the bottom (step A3).

If it is determined that the registered schedule includes no frequently-used term (No in step A3), a tag indicative of a special schedule is added to the registered schedule (step A4).

If it is determined that the registered schedule includes a frequently-used term (Yes in step A3), the schedule analysis process is completed without adding a tag indicative of a special schedule to the registered schedule.

Thus, special events “sports day” and “travel” as indicated by the schedules of user A stored in the schedule management memory 12c shown in FIG. 4 are stored with a special tag added thereto.

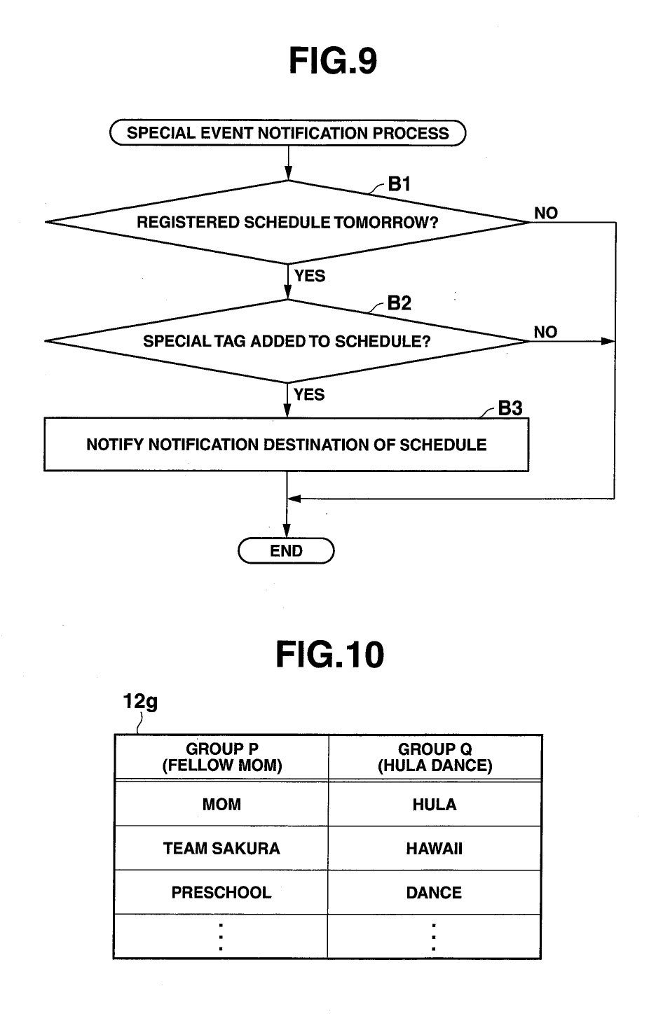

FIG. 9 is a flowchart showing a special event notification process to be performed by the information notification server 10.

The special event notification process is performed for all the schedules registered in the schedule management memory 12c regularly (at a fixed time every day, for example).

More specifically, when the special event notification process is started, it is determined whether there is a schedule on the next day of the schedule of user A which is stored in the schedule management memory 12c (see FIG. 4) (step B1).

Assume that today is Jul. 24, 2012. If it is determined that there is a schedule “payday” tomorrow, Jul. 25, 2012 (Yes in step B1), it is determined whether a special tag is added to the tomorrow's schedule “payday” (step B2).

Since, in this case, it is determined that the schedule “payday” is a regular schedule to which no special tag is added (No in step B2), the flow returns to the initial step and it is repeatedly determined by the tomorrow's schedule of user A whether there is another schedule (step B1).

If there is a schedule tomorrow but it is a regular schedule to which no special tag is added, no notification process is performed.

Assume that today is Oct. 9, 2012. If it is determined that there is a schedule “sports day of Asako” tomorrow, Oct. 10, 2012 (Yes in step B1), it is determined whether a special tag is added to the schedule “sports day of Asako” (step B2). If it is determined that a special tag is added to the schedule (Yes in step B2), in accordance with the address of a notification destination user B (a family including grandparents) corresponding to user A (a family including a grandchild of the grandparents) set in the user event notification destination setting table 12e, communication terminal 20B of user B is notified of the special schedule through mail M (schedule of the family of user A of October 10: “sports day of Asako”) (step B3).

In this case, for the reason of the special event “sports day of Asako” of user A (the family including a grandchild) that is notified to communication terminal 20B from the information notification server 10, the family of user B (the family including grandparents) is able to have a positive motivation to try to contact the family of user A, sending a message such as “Good luck for the sports day” and “We'll go to cheer for you at the sports day.” Thus, users A and B are able to promote communications with each other.

When the above special event notification process is completed with respect to the tomorrow's schedule of user A, the same special event notification process is performed with respect to those of the subsequent users such as users B and C. The communication terminal of the set notification destination user is notified of a tomorrow's schedule to which a special tag is added, via mail M.

Therefore, according to the special schedule analysis function and special schedule notification function of the information notification server 10 in the communication promotion system with the above configuration, a special schedule is distinguished from the schedules of each of users A and B registered in the schedule management memory 12c and managed with a special tag added thereto. Then, it is determined, for example, at a fixed time every day for each of the users whether there is a schedule to which a special tag corresponds. If it is determined that there is a special schedule tomorrow, the communication terminal 20 of the notification destination user is notified that there is a special schedule tomorrow in accordance with the address of the notification destination user set in the user event notification destination setting table 12e.

Assume that a family having a child is registered as user A and a family having grandparents of the child is registered as user B. If user A has a special schedule “sports day of Asako” as a tomorrow's schedule, user A notifies communication terminal 20B of user B, which is set as a notification destination of user A, of the tomorrow's schedule “sports day of Asako” of user A via mail M. Accordingly, for this reason, user B (grandparents) is able to promote communications with user A.

In the foregoing embodiment, a tag indicating whether each of the schedules stored in the schedule management memory 12c is a special schedule is determined by one of the above three methods (1) to (3).

In the schedule management memory 12c, a schedule can be stored over a long period of time without being erased immediately even though the schedule expires. When a schedule is newly input to the schedule management memory 12c, if the schedule is determined as a special one on the ground that its item is the same as that of a previously stored schedule or it is a rare schedule, a tag can be added to the schedule.

Accordingly, the usage term database 12d or the special event database 12f need not be provided.

Furthermore, a user can determine whether each of the schedules stored in the schedule management memory 12c is a special one and add a tag thereto when he or she registers it.

In the foregoing embodiment, on the day before a schedule to which a special tag is added, a notification destination in which the schedule is set is notified. However, the notification date is not limited to the day before the schedule but can be set on the current day or a later day.

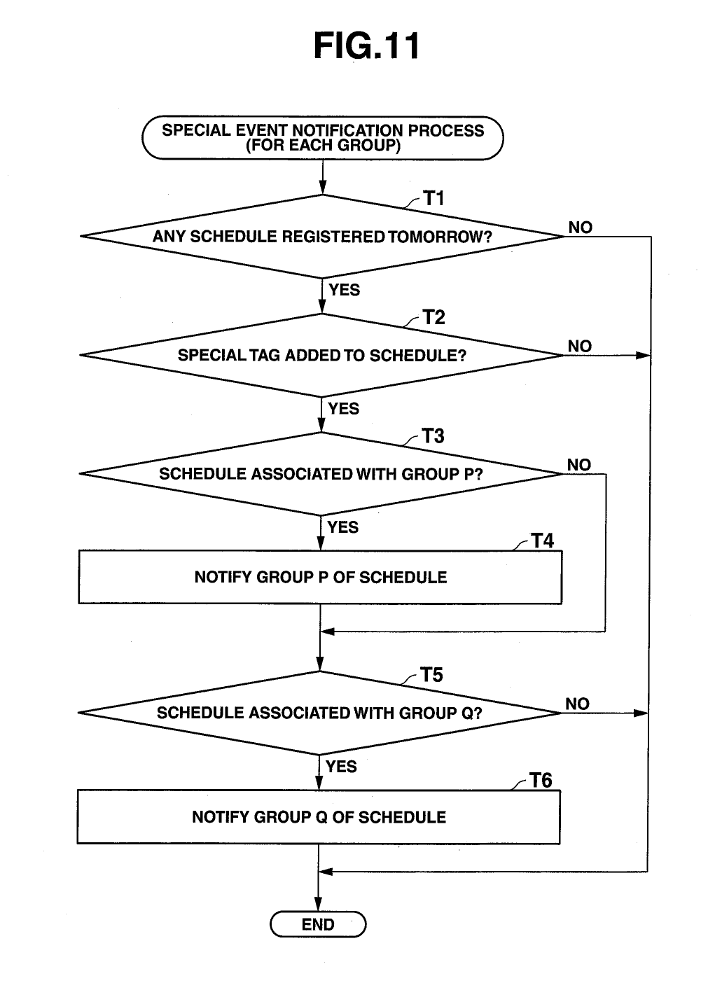

In the foregoing embodiment, of the user's schedules stored in the schedule management memory 12c, a schedule to which a special tag is added is notified to a user of a notification destination set in the user event notification destination setting table 12e. However, as will be described with respect to another embodiment below with reference to FIGS. 10 and 11, when a user belongs to a plurality of groups (for example, a group having the same hobby and a group of parents) registered in the information notification server 10, he or she can determine which of the groups is associated with a schedule to which a special tag is added and notify the members of the group of the schedule.

### Another Embodiment

In a special event notification function according to another embodiment, which is performed by the information notification server 10, an operating data area for a group term database 12g is included in the storage unit 12.

FIG. 10 is a table showing group terms stored in the group terms database 12g of the information notification server 10.

The group terms database 12g stores terms which are more frequently used in each of groups P and Q to which a user registered in the information notification server 10 belongs.

Assume that group P is a group of mothers having children who commute to their kindergartens (mom fellows) and group Q is a group of people who learn the Hula Dance. For group P, the terms such as “mom,” “team Sakura” and “kindergartens” are stored in the group term database 12g and for group Q, the terms such as “Hula,” “Hawaii” and “dance” are stored therein.

The user names and mail addresses of the members of groups P and Q stored in the group term database 12g are linked to a user database (not shown) that stores the user information (user name, mail address, group, etc.) registered in the information notification server 10 and then managed.

FIG. 11 is a flowchart showing a special event notification process (for each group) according to another embodiment which is performed by the information notification server 10.

As in the special event notification process described above with reference to FIG. 9, it is determined for each of the users registered in the schedule management memory 12c whether there is a tomorrow's schedule to which a special tag is added (steps T1 and T2).

If it is determined that a user has a tomorrow's schedule to which a special tag is added (Yes in steps T1 and T2), it is determined whether the schedule is associated with group P according to whether the schedule includes any of the terms of group P which are stored in the group term database 12g (step T3).

If it is determined that there is a schedule associated with group P (Yes in step T3), each of the users belonging to group P is notified of the items of the schedule in accordance with the mail address of the user, which is stored in the user database (not shown) (step T4).

If it is determined that the tomorrow's schedule to which a special tag is added (Yes in steps T1 and T2) is not associated with group P (No in step T3), it is determined whether the schedule is associated with group Q according to whether the schedule includes any of the terms of group Q which are stored in the group term database 12g (step T5).

If it is determined that the above schedule is associated with group Q (Yes in step T5), the communication terminal of each of the users belonging to group Q is notified of the items of the schedule in accordance with the mail address of the user which is stored in the user database (not shown) (step T6).

Therefore, according to the special schedule notification function (for each group) according to another embodiment of the information notification server 10 in the communication promotion system with the above configuration, it is determined for each user at a fixed time every day whether the user has a tomorrow's schedule to which a special tag is added. If the user has the schedule, it is also determined whether the items of the schedule are associated with one of the previously registered groups. If it is determined that the items of the schedule are associated with one of the groups, the communication terminal 20 of a registered user belonging to the group is notified of the items of the schedule.

Accordingly, when a family having a kindergarten child which belongs to, for example, group P (mom fellows) is registered as user A, if the tomorrow's schedule of user A includes a special schedule “sports day of ABC kindergarten,” the communication terminal 20 of each of the users who belong to group P associated with the special schedule is notified of the tomorrow's schedule “sports day of ABC kindergarten” via mail M. For this reason, each of the users who belong to group P is able to communicate with user A and their communications can be promoted.

A special schedule notification function for notifying a communication terminal of a notification destination set for each of the users by the user event notification destination setting table 12e according to the above embodiment and a special schedule notification function (for each group) for notifying a communication terminal of each of the users who belong to a group associated with the items of a special schedule according to said another embodiment of the special schedule can be combined with each other.

More specifically, for example, a tomorrow's special schedule of a certain user is notified to a notification destination user (communication terminal) set to correspond to the certain user, and it is determined whether the items of the schedule are associated with any group of the registered users. If it is determined that the items are associated with the group, the special schedule is notified to each (communication terminal) of the users in the group.

Accordingly, if each of the users has only to register and use his or her own schedule in the information notification server 10, he or she is easily contacted by members of a group associated with the schedule as well as previously registered relatives, acquaintances and the like for the reason of his or her special schedule, with the result that he or she can promote communications with a lot of different people.

In each of the above embodiments, the information notification server 10 is configured to manage a schedule of each of the users registered in the server 10, analyze a special schedule for each of the users and notify the special schedule to a communication terminal 20 of a notification destination user set by each of the users and a communication terminal 20 of each of the users who belong to a group associated with the items of the schedule. In contrast, communication terminals 20A and 20B of each of the users can be configured to manage their own schedules, analyze their special schedules and notify the special schedules to a communication terminal 20 of a notification destination user set by each of the users and a communication terminal 20 of each of the users who belong to a group associated with the items of the schedule.

In each of the above embodiments, the processes of the information notification server 10 and the data processed by the server 10, namely, the techniques for performing the special schedule analysis process shown in the flowchart of FIG. 8, the special event notification process shown in the flowchart of FIG. 9 and the special event notification process (for each group) according to said another embodiment shown in the flowchart of FIG. 11 and the data stored in the schedule management memory 12c shown in FIG. 4, the usage term database 12d shown in FIG. 5, the user event notification destination setting table 12e shown in FIG. 6, the special event database 12f shown in FIG. 7 and the group term database 12g shown in FIG. 10 are all programs that can be performed by a computer. These programs can be stored in and distributed to a memory card (ROM card, RAM card, etc.), a magnetic disk (floppy disk, hard disk, etc.), an optical disk (CD-ROM, DVD, etc.) and an external recording medium such as a semiconductor memory. The computer (CPU 11) of the information notification server 10 (communication terminals 20A and 20B) having a schedule management function causes the storage unit (12) to store the programs from external recording medium (13). The stored programs control the operation of the apparatus, with the result that the special schedule analysis function and the special event notification function as described above in each of the embodiments can be achieved and a similar process can be performed by the above methods.

The programs for achieving the above techniques can be transferred over the communication network N as program code. The program code can be loaded into the information notification server 10 (communication terminals 20A and 20B) having a schedule management function from the computer apparatus (program server), and the special schedule analysis function and the special event notification function can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information notification apparatus comprising:
a schedule storage unit which stores schedule data;
a special schedule determining unit which determines special schedule data in the schedule data stored in the schedule storage unit; and
a special schedule notification unit which notifies a communication terminal of the special schedule data.

2. The information notification apparatus according to claim 1, further comprising a notification destination specifying unit which specifies a notification destination of the special schedule data,
wherein the special schedule notification unit notifies the communication terminal of the notification destination of the special schedule data.

3. The information notification apparatus according to claim 1, further comprising a special tag adding unit which adds a tag to corresponding special schedule data in the schedule data,
wherein the special schedule determining unit determines special schedule data in the schedule data, to which a tag is added by the special tag adding unit.

4. The information notification apparatus according to claim 1, wherein when a user selects information indicating that schedule data is special schedule data, the special tag adding unit adds a tag to the schedule data.

5. The information notification apparatus according to claim 3, wherein the special tag adding unit includes a special schedule identifying unit which identifies, as special schedule data, schedule data, the number of which is not larger than a preset number, and adds a tag to the schedule data identified by the special schedule identifying unit.

6. The information notification apparatus according to claim 5, wherein the special schedule identifying unit includes a usage term storage unit which stores a term included in the schedule data to correspond to a usage frequency of the term, and identifies, as special schedule data, schedule data, which does not include a term whose usage frequency is not lower than a preset usage frequency.

7. The information notification apparatus according to claim 5, wherein the special schedule identifying unit includes a special term storage unit which stores a special term, and identifies, as special schedule data, schedule data and including a term stored in the special term storage unit.

8. The information notification apparatus according to claim 1, further comprising a time determining unit which determines a predetermined time,
wherein the special schedule determining unit determines special schedule data of a next day in the schedule data.

9. The information notification apparatus according to claim 2, further comprising:
a group notification destination setting unit which sets members belonging to each plurality of groups as a notification destination;
a group term storage unit which stores a term related to said each plurality of groups; and
a related-group determining unit which, when the special schedule determined by the special schedule determining unit includes a group-related term stored in the group term storage unit, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

10. The information notification apparatus according to claim 3, further comprising:
a group notification destination setting unit which sets members belonging to each plurality of groups as a notification destination;
a group term storage unit which stores a term related to said each plurality of groups; and
a related-group determining unit which, when the special schedule includes a group-related term, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

11. The information notification apparatus according to claim 4, further comprising:
a group notification destination setting unit which sets members belonging to each plurality of groups as a notification destination;
a group term storage unit which stores a term related to said each plurality of groups; and
a related-group determining unit which, when the special schedule includes a group-related term, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

12. The information notification apparatus according to claim 5, further comprising:
a group notification destination setting unit which sets members belonging to each plurality of groups as a notification destination;
a group term storage unit which stores a term related to said each plurality of groups; and
a related-group determining unit which, when the special includes a group-related term, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

13. The information notification apparatus according to claim 6, further comprising:
a group notification destination setting unit which sets members belonging to each plurality of groups as a notification destination;
a group term storage unit which stores a term related to said each plurality of groups; and
a related-group determining unit which, when the special schedule includes a group-related term stored in the group term storage unit, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

14. The information notification apparatus according to claim 7, further comprising:
a group notification destination setting unit which sets members belonging to each plurality of groups as a notification destination;
a group term storage unit which stores a term related to said each plurality of groups; and
a related-group determining unit which, when the special schedule includes a group-related term stored in the group term storage unit, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

15. The information notification apparatus according to claim 8, further comprising:
a group notification destination setting unit which sets members belonging to each plurality of groups as a notification destination;
a group term storage unit which stores a term related to said each plurality of groups; and
a related-group determining unit which, when the special schedule includes a group-related term stored in the group term storage unit, determines a group of the term as a group related to the special schedule,
wherein the notification destination specifying unit specifies, as a notification destination, the members belonging to said each plurality of groups set by the group notification destination setting unit to correspond to the group determined by the related-group determination unit.

16. A non-transitory recording medium on which a program to be executed by a computer of an electronic apparatus having a communication function is recorded, the program causing the computer to serve as:
a schedule storage unit which stores schedule data in a memory;
a special schedule determining unit which determines special schedule data in the schedule data;
a notification destination specifying unit which specifies a notification destination of the special schedule data; and
a special schedule notification unit which notifies a communication terminal of the notification destination of the special schedule data.
